(19) United States
(12) Patent Application Publication
(10) Pub. No.: US 2016/0212360 A1
(43) Pub. Date: Jul. 21, 2016

(54) IN-SITU INSPECTION OF POWER GENERATING MACHINERY

(71) Applicant: Siemens Energy, Inc., Orlando, FL (US)

(72) Inventors: James P. Williams, Orlando, FL (US); Joshua DeAscanis, Oviedo, FL (US); Jason E. Williams, Cocoa, FL (US); James F. Landy, Cape Canaveral, FL (US)

(21) Appl. No.: 14/601,278

(22) Filed: Jan. 21, 2015

(51) Int. Cl. H04N 5/33; H04N 5/232; H04N 5/225

(52) U.S. Cl. CPC H04N 5/33; H04N 5/2252; H04N 5/23238

(57) ABSTRACT

Thermographic inspection of an internal component (28, 34) of power production equipment (20) by inserting an ultrasound energizer (74A) into an inspection portal of the equipment to contact an exterior of the component, and inserting a camera scope via a second portal into an interior (52, 54) of the component. A motorized drive (66) may mount on a pilot fuel port (58) of a gas turbine to move the scope robotically within a combustor (28) and transition duct (34). A distal camera housing (69) on the scope pivots (64) and contains an infrared camera with a lateral field of view (85) that rotates about an axis 78 by rotating (73) a distal mirror head (70) on the housing or by rotating (73′) the housing (69′). Circumferential sets of thermographic images are acquired by rotating the field of view and translating it along a navigation path in the component interior.

### FIELD OF THE INVENTION

This invention relates to non-destructive internal inspection of installed power generating machinery, and more particularly to in-situ thermographic imaging of gas path inner surfaces of gas turbine combustor liners and transition ducts.

### BACKGROUND OF THE INVENTION

A common industrial gas turbine engine has a circular array of combustors. A transition duct channels combustion gas from each combustor to the first row of turbine blades. Combustion chambers and transition ducts commonly have metal inner liners for the combustion gas path. The inner surfaces of these liners have a thermal barrier coating (TBC), which may include one or more ceramic layers on a bond coat. The TBC is subject to wear and damage from cyclic thermal expansion, vibrations, heat, and particle impacts. The condition of the TBC is critical for protecting the gas path liners and other surrounding parts, so it is regularly inspected. This has been done by partly disassembling the engine. However, disassembly and reassembly is expensive and time-consuming, causing substantial down-time. It relieves installed stresses on components, thus modifying their in-situ shapes and clearances. It requires highly trained assembly technicians and relatively heavy equipment.

### BRIEF DESCRIPTION OF THE DRAWINGS

The invention is explained in the following description in view of the drawings that show:

FIG. 1 is a partial sectional side view of an upper half of a gas turbine engine known in the art.

FIG. 2 is a sectional side view of a combustor and transition duct showing aspects of an embodiment of the invention.

FIG. 3 is a sectional side view of a camera housing on an inspection scope positioned in the exit end of the transition duct.

FIG. 4 is a sectional side view of a second embodiment of a camera housing on the inspection scope positioned in the exit end of the transition duct.

### DETAILED DESCRIPTION OF THE INVENTION

The inventors recognized that thermographic inspection of the inner surfaces of gas turbine components in-situ would greatly reduce expense and down-time, would make more frequent inspection intervals feasible, and would extend the safe life of the components before replacement or repair. Herein, “in-situ” means the component being inspected remains installed in the engine.

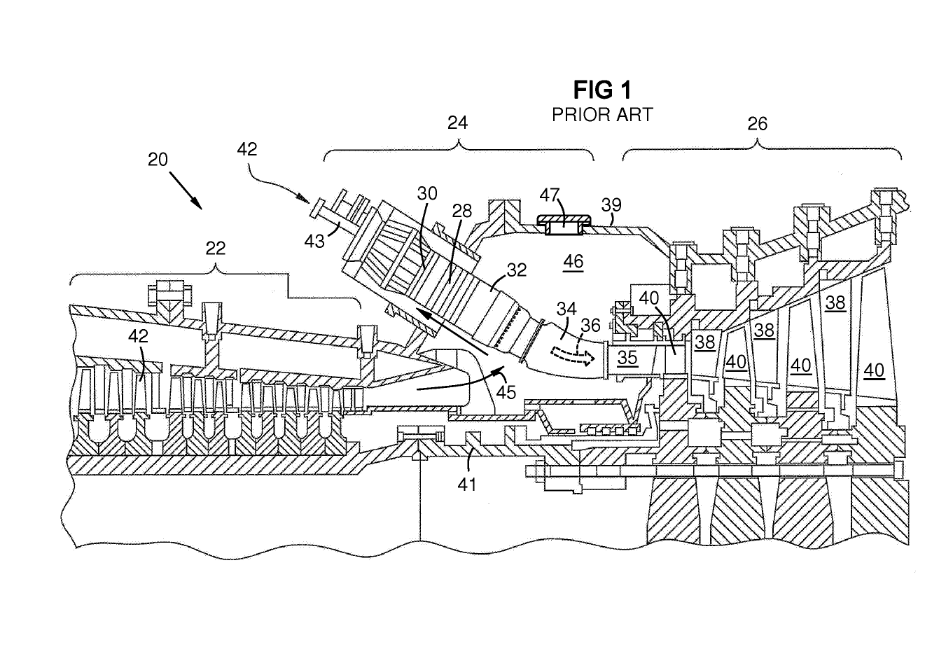

FIG. 1 is a partial side sectional view of a gas turbine engine 20 with a compressor section 22, a combustion section 24, and a turbine section 26 as known in the art. One combustor 28 of a circular array of combustors is shown. Each combustor 28 has an upstream end 30 and a downstream end 32. A transition duct 34 and an exit piece 35 thereof transfer the combustion gas 36 from the combustor to the first row of airfoils of the turbine section 26, which includes stationary vanes and 38 rotating blades 40. Compressor blades 42 are driven by the turbine section via a common shaft 41. Fuel 42 enters each combustor via a central pilot fuel nozzle 43, and enters by tubes to a circular array of premix injectors. Compressed air 45 enters a plenum 46 around the combustors. It then enters the upstream end 30 of the combustor, and is mixed with the fuel therein for combustion. The compressed air 45 also surrounds the combustor 28 and transition duct 34 to cool them. It has a higher pressure than the combustion gas 36 in the combustor and in the transition duct. Maintenance access ports 47 are provided at various locations on the engine, including on the outer casing 39 of the combustion section as shown.

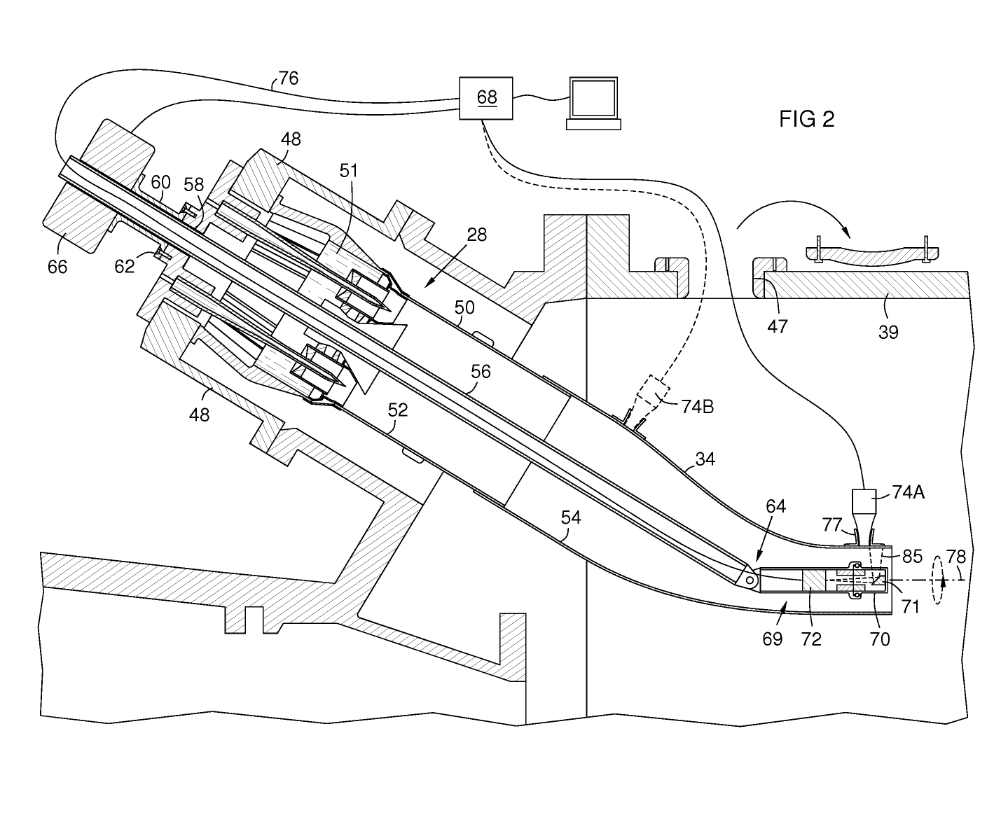

FIG. 2 shows a combustor assembly 28 including a combustion chamber 50 mounted to a combustor cap 51 that is mounted inside a combustor outer casing 48. The combustion chamber 50 and the transition duct 34 have inner surfaces 52, 54 coated with a thermal barrier coating (TBC), which commonly includes one or more ceramic layers on a bond coat. The pilot fuel nozzle 43 (FIG. 1) has been removed from the pilot fuel nozzle port 58, and an elongated inspection scope 56 is inserted in its place extending through the combustor cap 51. A mounting tube 60 for the inspection scope may be mounted to the pilot fuel nozzle port 58 via a collar 62. A computer 68 may control the scope robotically via a motorized drive 66 to extend into the combustor and to optionally rotate. Herein “robotically” means controllably operated by a computer along an automated predetermined navigation path and/or operated interactively under human direction via the computer. The scope may robotically articulate at a pivot joint 64 for example as taught in US patent application publication 2013/0335530A1, which is incorporated herein by reference. The scope may have a distal camera housing 69 with side-scanning infrared camera equipment. “Side-scanning” herein means the field of view 85 is substantially normal to the rotation axis 78. The axis may coincide with, or be parallel to, a geometric axis of the camera housing. The camera housing can be moved automatically by the motorized scope along a predetermined navigation path. The camera housing 69 may have a rotatable head 70 containing a prism or mirror 71 that reflects image photons into a digital camera 72. The head 70 may have an open port for the field of view 85, or it may be made of an infrared transparent material or have a window of such material.

The computer 68 may programmatically control an inspection process for detecting defects in the TBC by providing control signals to the motorized drive 66, and to one or more acoustic transducers 74A, 74B. The computer 68 additionally receives input 76 from the camera 72, and may perform processing thereon for TBC analysis. Processing may include digital stitching of the camera images into a panoramic view of the inner surfaces 52, 54, contouring and analyzing thermal patterns thereon, and interactive display thereof for human view as taught for example in U.S. patent application Ser. No. 14/526,609 filed 29 Oct. 2014 (attorney docket number 2014P17920US), United States patent application publication number (to be determined), which is incorporated by reference herein. A technician may place one or more transducers 74A, 74B in contact with outer surfaces of the components 34, 50 at predetermined positions. Brackets 77 for transducer placement may be provided on the outer surfaces of the components 34, 50. The transducer 74A may be fastened to the bracket 77 to insure consistent acoustic coupling to the components across successive inspections, or an acoustic coupling material may be used. The inner surfaces 52, 54 can be thermographically inspected in-situ. A transducer 74A may be re-positioned 74B during the inspection process by stopping the imaging, moving the transducer, and restarting the imaging. The inspection does not limit each image to be taken directly under a transducer, since a transducer vibrates a portion of the component sufficiently to reveal flaws over an energized area around the transducer.

A baseline panoramic thermographic scan may be compiled after initial installation of the gas turbine. During each subsequent thermographic inspection, the computer 68 may compile a panoramic scan, and may digitally subtract the original baseline scan or any previous scan from the current scan in order to expose changes that have occurred since the earlier scan. The changes may be contoured, quantified, and plotted in a time series to expose any acceleration in wear rates. Discontinuities in the TBC such as de-laminations, de-bonds, cracks, and spalling, as well as cracks in the metal substrates cause localized heating under ultrasound stimulation. This heating appears in the thermographic images, and can be enhanced by previous image subtraction. The panoramic image may be digitally projected onto a visible image or onto a 3-D model of the inner surface for display, allowing an interactive virtual walk-through inspection.

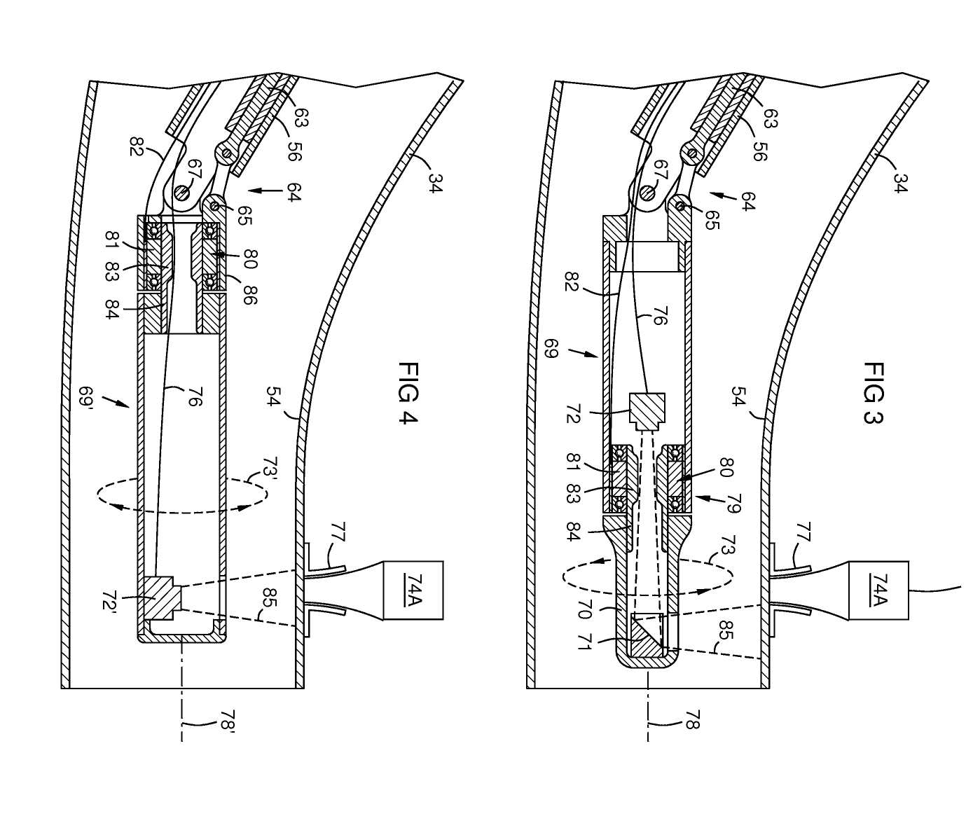

FIG. 3 is sectional side view of an embodiment of the camera housing 69 of the inspection scope with a rotatable head 70 thereon positioned in the exit end of the transition duct 34. The pivot joint 64 may be robotically controlled as known by an actuator 63 operating against a moment arm relative to a main pivot axis 67. For example the actuator may act against a second pivot axis 65 offset from the main pivot axis 67. The head 70 is rotatable about an axis 78, which may coincide with, or be parallel with, a geometric centerline of the camera housing 69. The computer may translate the head robotically along a path that substantially follows, or is parallel to, a geometric centerline of the interior surfaces 52, 54.

Head rotation 73 may be enabled for example by a hollow stepper motor 80 with powered stator 81 in the distal end 79 of the camera housing 69, and a hollow unpowered rotor 83 with a hollow shaft 84 on which is mounted the head 70. The stator coils may be powered and modulated by a wire 82 from the computer 68 (FIG. 2). Such rotating head 70 requires no wires or cables, so it can rotate without limitation about an axis 78. An alternate rotary drive means, not shown, is a servomotor or stepper motor in the distal end of the camera housing 69 with a pinion that drives an annular gear in the head 70, which is mounted on a bearing of the camera housing.

The head 70 has a prism or mirror 71 that redirects the lateral field of view 85 to the camera 72 through the hollow stepper motor 80. The camera 72 may use fixed focus, or a known automatic focusing method, or it may be focused by the computer 68 based on the known position of the head 70 relative to a 3-dimensional virtual model of the interior surfaces 52, 54. Alternately, the sensor of the camera may be replaced with a bundle of infrared optical fibers, not shown, that transmits the image through the inspection scope to an external camera. A circumferential set of thermographic images can be acquired at each one of a sequence of axial positions along the interior surfaces 52, 54 by rotation of the head 70. Optionally the head can be rotated and translated proportionally to provide a helical scan of the inner surfaces 52, 54.

FIG. 4 is a sectional side view of another embodiment of a camera housing 69′ positioned in the exit end of the transition duct 34. This camera housing 69′ rotates about an axis 78′, which may substantially coincide with a geometric centerline of the camera housing. Rotation can be enabled, for example, by a stepper motor 80 in a pivot hub 86 attached to the pivot joint 64. The stepper motor may have a hollow unpowered rotor 83, a hollow shaft 84, and a stator 81 powered by a conductor wire 82. Alternately, rotation of the housing may be provided by a servomotor or stepper motor in the pivot hub 86 with a pinion that drives an annular gear in a proximal end of the housing 69′, which housing is mounted on a bearing of the pivot hub 86. An infrared camera 72′ is mounted in the camera housing 69′ with a field of view 85 oriented normally to the rotation axis 78 for thermographic imaging of the interior surface 54.

During rotation of the camera housing 69′, the camera 72′ acquires a circumferential set of thermographic images, and transmits them via connection wire 76 to the computer 68 (FIG. 2). The computer controls the inspection scope robotically to translate the camera housing 69′ along a path that substantially follows, or is parallel to, a geometric centerline of the inner surfaces 52, 54. The camera housing 69′ may rotate in alternating directions to acquire a sequence of circumferential sets of thermographic images covering the interior surfaces 53, 54. The camera connection wire 76 may be coiled to tolerate repeated alternating rotations. Rotation is not needed more than 180 degrees in each direction from a neutral position for each circumferential scan.

The camera 72′ may be a known type such as a USB infrared or multi-spectral camera with fixed focus, or an auto-focus technology such as contrast detection or phase detection. Alternately, the camera 72′ may be remotely focused by the computer 68 based on the known position of the camera relative to a 3 dimensional virtual model of the inner surfaces 52, 54. Optionally, a focus-assist lamp or focus spot projector may be provided to assist in focusing. Alternately, a visible-spectrum camera (not shown) mounted parallel to the imaging camera 72′ may focus with visible technology and provide focus control to the infrared imaging camera 72′.

Alternately to the embodiments shown in FIGS. 3 and 4, a side scanning infrared camera may be added to any of the camera housing embodiments shown in US patent application publication 201310335530A1. Such a combined inspection scope provides coordinated visible and thermographic scanning after cool-down of the engine without disassembly thereof.

Applying the ultrasound to the outer surfaces of the components 34 and 50 instead of the inner surfaces eliminates damage to the TBC caused by contact with the transducer, and eliminates the need for ultrasound elements in the camera housing 69. Moreover, acoustic coupling to the uncoated metal surface may be more effective than to the ceramic coating surface, and lateral dissemination of the acoustic energy through the metal to an entire inspection region is not affected by engine-specific flaws in the ceramic coating. No disassembly of the engine is required other than removing the pilot nozzle 43 and opening an inspection port 47. The outer casing 39 can remain installed around the combustion section.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of inspecting a component installed in a gas turbine engine, the method comprising:
extending an infrared image receiver into an interior of the component via a first portal of the engine;
extending an ultrasonic energy transducer to an exterior surface of the component via a second portal of the engine;
coupling ultrasonic energy into the exterior surface of the component by energizing the transducer; and
receiving a thermographic image of a surface of the interior of the component under influence of the ultrasonic energy via the image receiver.

2. The method of claim 1, wherein the component comprises a combustion chamber in a combustor assembly, the first portal comprises a pilot fuel nozzle port on the combustor assembly, and further comprising removing a pilot fuel nozzle from the first portal and extending the image receiver into the interior of the component on an elongated scope via a motorized drive mounted on the first portal.

3. The method of claim 2, further comprising:
providing a mirror in a rotatable head on a camera housing of the scope, wherein the mirror receives the thermographic image from the interior surface and reflects the thermographic image to a digital camera in the camera housing of the scope;
rotating the head about an axis substantially aligned with a geometric centerline of the interior surface of the component, and acquiring a circumferential set of thermographic images thereof by the camera;
translating the head along a path that substantially follows the geometric centerline, and repeating the rotating and acquiring step to acquire a sequence of circumferential sets of thermographic images of the interior surface; and
communicating the thermographic images to a computer.

4. The method of claim 3, wherein the second portal is a maintenance access port on an outer casing of a combustion section of the gas turbine engine and further comprising not removing said the outer casing from the engine for the inspection.

5. The method of claim 2, further comprising:
providing a prism or mirror in a rotatable head on a camera housing of the scope, wherein the prism or mirror redirects infrared light from the interior surface to a digital camera in the camera housing of the scope;
rotating the head about an axis substantially aligned with a geometric centerline of the interior surface while translating the head along a path that substantially follows, or is substantially parallel with, the geometric centerline while acquiring a helical thermographic scan of the interior surface by the camera along said path; and
communicating the helical thermographic scan to a computer.

6. The method of claim 2, further comprising the steps of:
a) positioning the transducer at a location on the exterior of the component;
b) positioning the infrared image receiver in the interior of the component within a thermal excitation range of the location of the transducer;
c) scanning the interior surface within the thermal excitation range with the image receiver to obtain the thermographic image;
d) recording the thermographic image;
e) relocating the transducer to another location on the exterior of the component; and
f) repeating steps b) to e) until the interior surface is fully imaged and recorded.

7. The method of claim 6, further comprising digitally combining multiple thermographic images of the surface into a panoramic thermographic image of the interior surface, contouring and analyzing thermal patterns thereon, and displaying the panoramic thermographic image on a computer monitor for human view.

8. The method of claim 7, further comprising digitally subtracting a previous panoramic thermographic image of the interior surface from the panoramic image, and displaying a difference image showing thermographic changes between two inspections, wherein the previous panoramic thermographic image was taken in accordance with claim 7 during a previous inspection of the interior surface.

9. A method of in-situ thermographic inspection of an internal component installed in a power production equipment comprising:
contacting an exterior uncoated surface of the component with an ultrasound transducer via a first portal on a casing of the power production equipment;
inserting an inspection scope into an interior of the component via a motorized drive mounted on a second portal of the power production equipment;
providing an infrared camera in a distal housing on the inspection scope, the camera having a field of view that is robotically rotatable about an axis of the housing; and
robotically rotating and translating the field of view via a computer to acquire a thermographic image with the camera of a coated surface of the interior of the component under influence of the ultrasound transducer.

10. The method of claim 9, further comprising assessing a condition of the coated surface using the thermographic image.

11. The method of claim 9, further comprising assessing a condition of the coated surface by comparing the thermographic image with a previous thermographic image of the coated surface.

12. An apparatus comprising:
a gas turbine engine comprising a combustor assembly having a pilot fuel nozzle port disposed within a casing having an access portal;
an elongated scope extended into an interior of the combustor assembly from a motorized drive attached to the pilot fuel nozzle port;
an infrared camera at a distal end of the elongated scope; and
an ultrasonic energy transducer disposed on an uncoated exterior of the combustor assembly via the access portal;
wherein the camera is operative to obtain an image of a coated interior surface of the combustor assembly under influence of the ultrasonic energy transducer.

13. The apparatus of claim 12, wherein the infrared camera is mounted to a rotatable head; and further comprising;
a computer operatively programmed to rotate the head while controlling the motorized drive such that the camera follows a predetermined navigation path along, or parallel to, a geometric centerline of the interior surface.

14. The apparatus of claim 12, further comprising a prism or mirror disposed on a rotatable head on the distal end of the elongated scope operable to give the infrared camera a rotatable view of the coated interior surface.
